(19) United States
(12) Patent Application Publication
(10) Pub. No.: US 2008/0226165 A1
(43) Pub. Date: Sep. 18, 2008

(54) Apparatus and Method of Creating Composite Lookup Table

(75) Inventor: Takeshi Wada, Kagoshima-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/049,133

(22) Filed: Mar. 14, 2008

(30) Foreign Application Priority Data
Mar. 14, 2007 (JP) 2007-065117

(51) Int. Cl. G06K 9/00

(52) U.S. Cl. 382/167

(57) ABSTRACT

A method of creating a composite lookup table referred to when lattice points distributed in a color space of first image data are sequentially converted into lattice points distributed in a color space of second image data by a plurality of conversion profiles. When an input value range to which a next conversion profile can be input is limited, an intermediate value obtained by conversion by a previous conversion profile is adjusted such that the intermediate value is within an input value range of a corresponding lookup table, and is input to the next conversion profile. When the input value range to which the next conversion profile can be input is not limited, the intermediate value obtained by conversion by the previous conversion profile to is input to the next conversion profile without any adjustment. A composite lookup table is created defining correspondences between the lattice points distributed in the color space of the first image data and the lattice points distributed in the color space of the second image data.

### BACKGROUND

1. Technical Field

The present invention relates to an apparatus and method of creating a composite lookup table.

2. Related Art

A technique has been proposed that analyzes image data to acquire feature information of the image data and automatically performs appropriate image quality adjustment on the basis of the feature information (for example, see JP-A-2003-69826). In addition, a technique for automatically adjusting image quality according to such image data on the basis of a three-dimensional lookup table has been proposed.

In the conversion process by the three-dimensional lookup table disclosed in JP-A-2003-69826, interpolation is performed on the basis of correspondences before and after a finite number of conversion processes that are defined in the three-dimensional lookup table. Therefore, the range of input values that can be converted by the three-dimensional lookup table is finite. When conversion is performed by the three-dimensional lookup table, it is necessary to adjust the input values within a predetermined range beforehand.

Meanwhile, when image data is handled by various apparatuses, various conversion profiles are used to convert image formats (color spaces) that can be used by the apparatuses. Among the conversion profiles, a transform such as a determinant, and not a lookup table, is used to convert an input value into an output value. When the transform is used, generally, the range of input values is not limited unlike when a three-dimensional lookup table is used.

When a series of conversion processes in which a conversion process by the three-dimensional lookup table that limits the input value range and a conversion process by the transform that does not limit the input value range are continuously performed, the input value range of the three-dimensional lookup table is narrowed, and the range of values used in all the conversion processes is limited. That is, since the three-dimensional lookup table that limits the input value range is included in the conversion processes, the input value range is limited even in the conversion process by the transform that does not limit the input value range. Such a limit in the range of values used in the conversion process causes loss of information on reproducible colors, which results in low color reproducibility.

### SUMMARY

The invention provides an apparatus and method of creating a composite lookup table without deteriorating color reproducibility.

According to one aspect of the invention, when a composite lookup table that performs a series of conversion processes using two or more conversion profiles is created, a sequential conversion unit sequentially converts representative input points that are selected from a color space of input image data using a series of conversion profiles to acquire representative output points. During the sequential conversion of the representative input points by the sequential conversion unit, when the next conversion profile is a lookup table, an adjusting unit adjusts an intermediate value obtained by conversion by a previous conversion profile such that the intermediate value is within the input value range of the lookup table and inputs the adjusted intermediate value to the next conversion profile. Meanwhile, when the next conversion profile is a transform, the adjusting unit inputs the intermediate value obtained by conversion by the previous conversion profile to the next conversion profile without any adjustment. A composite lookup table creating unit defines correspondences between the representative output points that are finally acquired from the adjustment by the sequential conversion unit and the representative input points, which are conversion sources, to create a composite lookup table.

The conversion profiles include at least a lookup table and a transform, and are arranged in a predetermined order, thereby setting a series of conversion processes. Therefore, it is assumed that the conversion profile, which is the lookup table, is set and the conversion profile, which is the transform, is set immediately after conversion is performed by a certain conversion profile. In the latter case, the adjusting unit inputs the intermediate value obtained by conversion by the previous conversion profile to the next conversion profile, which is the transform, without any adjustment. Since the conversion profile, which is the transform, has no limitation in the input value range, there is no problem when the intermediate value is input to the next conversion profile without any adjustment, and a large range of values can be input. As a result, high color reproducibility is ensured. In contrast, in the former case, the adjusting unit adjusts the intermediate value obtained by conversion by the previous conversion profile, and inputs the adjusted intermediate value to the next conversion profile, which is the lookup table. For example, when the input value range of the lookup table is limited to a value that is equal to or greater than 0, a negative intermediate value is adjusted to be equal to or greater than 0. In this way, an inconvertible input value is prevented from being input to the conversion profile, which is the lookup table.

Further, it is necessary to adjust the intermediate values out of the input value range of the lookup table such that the intermediate values can be input to the next conversion profile, which is the lookup table. In addition, the intermediate values around the upper and lower limits of the input value range of the lookup table may be adjusted such that they can be input to the next conversion profile. For example, the adjustment of the intermediate value may be performed such that continuity between the adjusted value of the intermediate value out of the input value range of the lookup table and the adjusted value of the intermediate value around the upper and lower limits of the input value range of the lookup table is maintained. In this case, the loss of the grayscale of the intermediate value after adjustment is prevented and thus a natural conversion result is obtained.

In the invention, the conversion profiles are not particularly limited. For example, a variable profile having a conversion result that is variable according to input image data may be used as the conversion profile. In this case, the variable profile may be used as the conversion profile serving as the lookup table.

The invention can be applied to a composite lookup table creating apparatus and an image conversion program that allows a hardware component, such as a computer, to execute the above-described functions, as well as to the method of creating the composite lookup table. In addition, the invention includes a composite lookup table creating method as well as a composite lookup table creating apparatus. Further, the composite lookup table creating apparatus is not limited to a single apparatus and may be incorporated into another apparatus. For example, the invention can be applied to a printing apparatus, an image processing apparatus, and a personal computer having the function of the composite lookup table creating apparatus. Furthermore, the units of the composite lookup table creating apparatus according to the invention may be distributed in a plurality of apparatuses. For example, a personal computer may execute the functions of some of the units in the composite lookup table creating apparatus according to the invention and a printing apparatus may execute the functions of the other units. Moreover, the units of the composite lookup table creating apparatus according to the invention may be distributed through a network.

### BRIEF DESCRIPTION OF THE DRAWINGS

The invention is described with reference to the accompanying drawings, wherein like numbers reference like elements.

FIG. 1 is a block diagram illustrating an image converting apparatus according to an embodiment of the invention.

FIG. 2 is a flowchart illustrating an image converting process.

FIG. 3A is a histogram illustrating sampling image data; and FIG. 3B is a luminance correction amount conversion diagram.

FIG. 4 is a diagram illustrating a variable profile.

FIG. 5 is a diagram illustrating an APF-LUT.

FIG. 6 is a diagram illustrating interpolation.

FIG. 7 is a diagram schematically illustrating an example of a conversion sequence.

FIG. 8 is a diagram illustrating the distribution of representative input points.

FIG. 9 is a diagram illustrating a process of calculating representative output points.

FIG. 10 is a flowchart illustrating a sequential conversion process.

FIG. 11 is a diagram illustrating an example of the adjustment of an intermediate value.

FIG. 12 is a diagram illustrating another example of the adjustment of an intermediate value.

FIG. 13 is a diagram illustrating an example of a composite LUT.

FIG. 14 is a block diagram illustrating an image converting apparatus according to a modification of the invention.

### DESCRIPTION OF EXEMPLARY EMBODIMENTS

Hereinafter, exemplary embodiments of the invention are described in the following order:

(1) The structure of an image converting apparatus;

(2) An image converting process; and

(3) Modifications.

### (1) Structure of Image Converting Apparatus

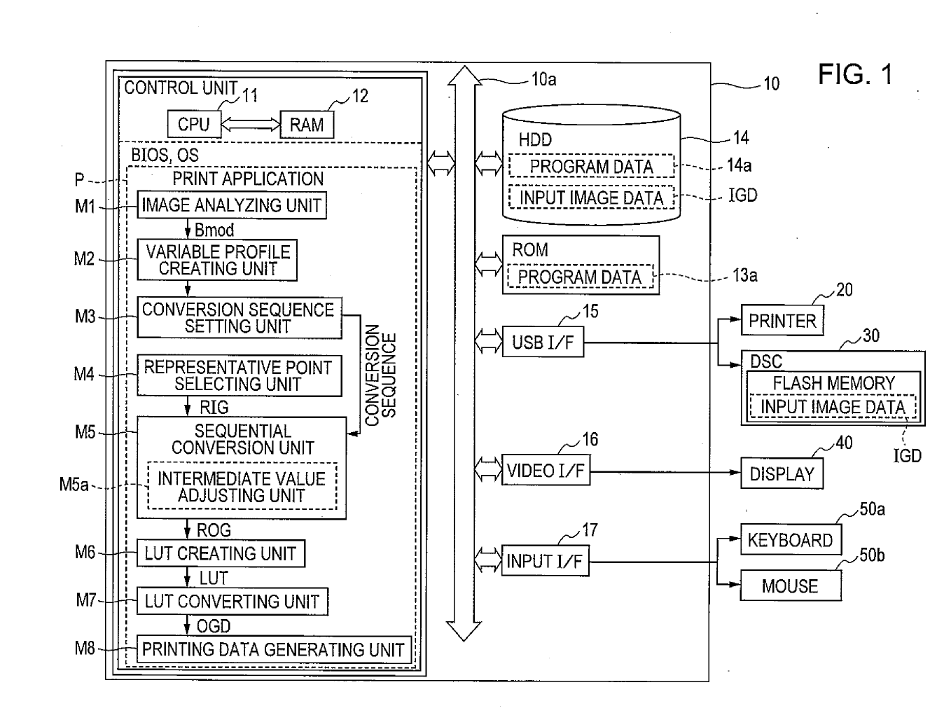

FIG. 1 is a block diagram schematically illustrating the hardware and software structure of a computer that executes the function of an image converting apparatus including a lookup table creating device according to an embodiment of the invention. In FIG. 1, a computer 10 includes components that are connected to a bus 10a such that they can communicate with each other. Specifically, the computer 10 includes a control unit C having a CPU 11 and a RAM 12, a ROM 13, a hard disk (HDD) 14 that records a large amount of data on a magnetic disk, a USB I/F 15 that connects an external printer 20 and a digital still camera (DSC) 30, a video I/F 16 that connects an external display 40, an input I/F 17 that connects external input devices, such as a keyboard 50a and a mouse 50b. Strictly, the components have different data communication schemes through the bus 10a, but a chipset (not shown) enables the components to communicate with each other.

The CPU 11 reads out program data 13a and 14a from the ROM 13 and the HDD 14, respectively, and expands the read data on the RAM 12, thereby controlling the control unit C to execute a BIOS, an operating system (OS) on the BIOS, and a print application P on the OS. The program data 14a required to execute the OS or the print application P has been installed in the HDD 14 beforehand. However, the program data 14a may be stored in an optical disk drive or a flash memory instead of the HDD 14. Although not shown in the drawings, a driver for access to a flash memory 31 provided in the DSC 30 and a driver that outputs images to the display 40 are installed in the control unit C.

When a user operates the keyboard 50a or the mouse 50b to designate input image data IGD while viewing a UI screen displayed on the display 40, the print application P executes a series of processes required to read the designated input image data IGD and print an image corresponding to the read data with the printer 20. The input image data IGD may be acquired from the HDD 14, the flash memory 31 of the DSC 30, another recording medium, or a communication medium. The print application P includes a plurality of modules (units) M1 to M8, and the control unit C executes the functions of the modules M1 to M8, thereby achieving each unit M1 to M8 according to this embodiment of the invention.

The image analyzing unit M1 acquires the input image data IGD that is designated as a printing object, and reduces the input image data IGD to a QVGA (320 pixels×240 pixels) size to generate sampling image data SGD. In the input image data IGD acquired from the DSC 30, the colors of pixels are specified by color signals that indicate the coordinates in a color space used by the DSC 30. Similarly, in the input image data IGD acquired from the HDD 14, the colors of pixels are specified by color signals that indicate the coordinates in the color space designated when the input image data IGD is finally stored in the HDD 14. When the input image data IGD is compressed by a compression standard, such as a JPEG standard, the image analyzing unit M1 expands the input image data IGD to generate the sampling image data SGD. The image analyzing unit M1 collects statistics of the color signals of the pixels in the sampling image data SGD, and acquires the statistical information as feature information of the sampling image data SGD. The image analyzing unit M1 sets variable parameters that set a conversion rule in a variable profile, on the basis of the feature information of the sampling image data SGD.

The variable profile creating unit M2 acquires the variable parameters on the basis of the feature information, and creates a variable profile on the basis of the variable parameters. The creation of the variable profile is described below, and an image conversion rule for improving image quality according to the variable parameters is defined by the variable profile. The conversion sequence setting unit M3 acquires the color space of the input image data IGD and the color space of output image data OGD that can be output to the printing data generating unit M8 in a subsequent state, and sets a series of conversion processes that convert the color space of the input image data IGD into the color space of the output image data OGD. As described above, since image processing for improving image quality is performed by the variable profile based on the variable parameters, conversion by the variable profile is also put in a series of conversion processes. In addition, conversion by a source (input-side) ICC profile of the DSC 30 or a destination (output-side) ICC profile of the printer 20 is put in a series of conversion processes. The ICC profile is a conversion profile that defines the correspondence between the color space used by a device and an absolute color space.

The representative point selecting unit M4 selects representative points (representative input points RIG) defining the correspondence in a lookup table (hereinafter, referred to as an LUT). In this embodiment, lattice points (for example, 17³ lattice points) that are uniformly distributed in the entire color space of the input image data IGD are selected as the representative input points.

The sequential conversion unit M5 sequentially converts the representative input points RIG represented in the color space of the input image data IGD using a series of conversion profiles set by the conversion sequence setting unit M3 to finally acquire representative output points ROG represented in the color space of the output image data OGD. The sequential conversion unit M5 includes as a sub-module an intermediate value adjusting unit M5a. When an intermediate value is obtained by conversion by one conversion profile, the intermediate value adjusting unit M5a determines whether the next conversion profile is the LUT. When it is determined that the next conversion profile is the LUT, the intermediate value adjusting unit M5a compares the input value range of the conversion profile with the intermediate value. When the intermediate value is out of the input value range, the intermediate value adjusting unit M5a adjusts the intermediate value to fall within the input value range.

The LUT creating unit M6 creates on the RAM 12 an LUT that defines a plurality of correspondences between the representative input points RIG and the representative output points ROG before and after the sequential conversion unit M5 performs conversion. The LUT converting unit M7 acquires the input image data IGD and converts the input image data IGD into the output image data OGD with reference to the LUT. During this conversion, interpolation is performed. The converted output image data OGD is output to the printing data generating unit M8, and the printing data generating unit M8 converts the received output image data OGD into printing data that can be processed by the printer 20. For example, the printing data generating unit M8 sequentially performs conversion into an ink amount space that can be used by the printer 20, a half tone process, and a micro weave process, and the printer 20 prints images.

### (2) Image Converting Process

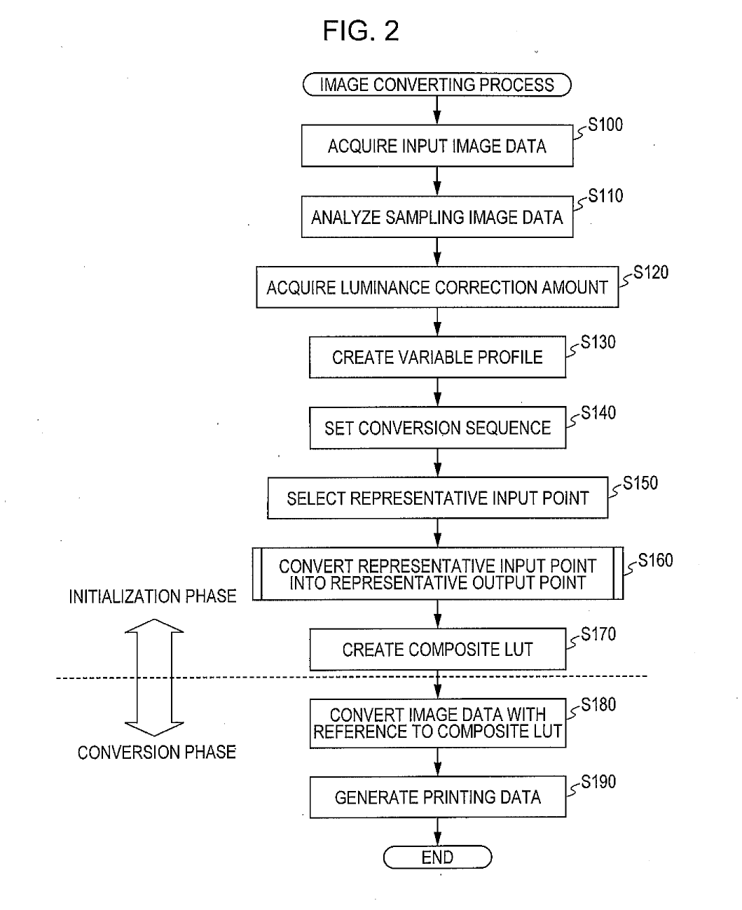

FIG. 2 is a flowchart illustrating an image converting process performed by the above-described structure. In Step S100, when the user designates the input image data IGD, which is a printing object, the image analyzing unit M1 acquires the input image data IGD. In this embodiment, it is assumed that JPEG data stored in the flash memory 31 of the DSC 30 is designated. In Step S110, the image analyzing unit M1 expands the JPEG data, and performs a size reduction process, such as decimation, to generate sampling image data SGD having a QVGA size that is represented in a YCbCr color space. Step S110 collects statistics of the color signals (YCbCr) of the pixels in the sampling image data SGD.

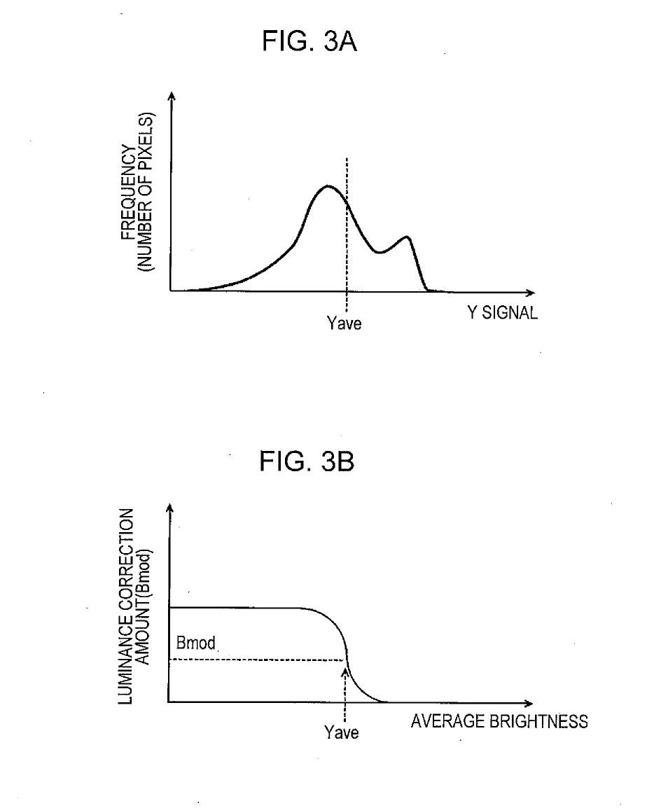

FIG. 3A is a histogram illustrating statistics of Y signals (Y signals indicating brightness are also included in the concept of the invention) serving as the color signals. In FIG. 3A, a horizontal axis indicates the value of the Y signal, and a vertical axis indicates the number of pixels (frequency). In Step S110, an average brightness Yave is calculated from the histogram. In Step S120, a luminance correction amount Bmod corresponding to the average brightness Yave is acquired from a luminance correction amount conversion diagram shown in FIG. 3B. In FIG. 3B, a horizontal axis indicates the average brightness Yave, and a vertical axis indicates the luminance correction amount Bmod [%]. In addition, in FIG. 3B, the luminance correction amount Bmod corresponding to each average brightness Yave is defined. As shown in FIG. 3B, the luminance correction amount Ymod is defined such that the luminance increases, when the average brightness Yave is low. The luminance correction amount Bmod corresponds to the variable parameter according to this embodiment, and a variable profile, which is described below, is created on the basis of the luminance correction amount Bmod that is set as the variable parameter.

In this embodiment, statistical information of the color space of the input image data IGD is analyzed, but the invention is not limited thereto. For example, the sampling image data SGD may be converted into the color space of the output image data OGD, and its statistical information may be analyzed. In addition, the average brightness Yave of the entire region may be calculated, or it may be calculated for each of a plurality of divided regions. In this way, when the luminance correction amount Bmod is set as the variable parameter, in Step S130, a variable profile is created on the basis of the luminance correction amount Bmod.

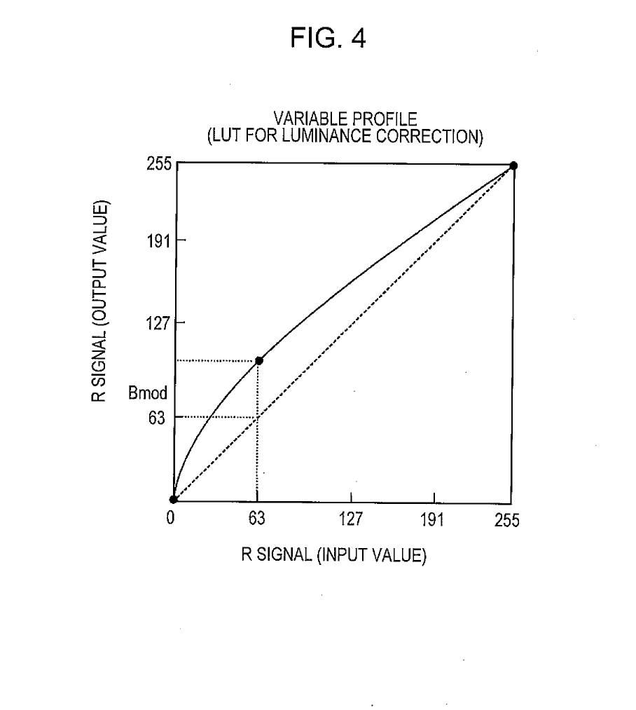

FIG. 4 is a diagram illustrating an example of the variable profile created in this embodiment. FIG. 4 shows the relationship between an input value (horizontal axis) and an output value (vertical axis) that are converted by the variable profile for RGB channels in an eRGB color space, which is described below. As shown in FIG. 4, at a low gray-scale value (63), which is a quarter of the input value range (for example, a range of 256 grayscale values from 0 to 255 in this embodiment), the variable profile is created such that values in the RGB channels are increased by the luminance correction amount Bmod acquired in Step S120. The other grayscale values are interpolated by a spline curve passing through three points (input value, output value)=(0, 0), (63, 63+Bmod), (255, 255). A variable profile in which the conversion result is variable according to the luminance correction amount Bmod, serving as the variable parameter, is created by defining the correspondence between the input value and the output value by the variable profile. The variable profile makes it possible to correct the input image data IGD that is entirely dark due to a small average value of Y signal to increase the luminance thereof. The smaller the average value of the Y signal becomes, the larger the increment becomes, which makes it possible to automatically perform appropriate luminance correction on each of the input image data IGD.

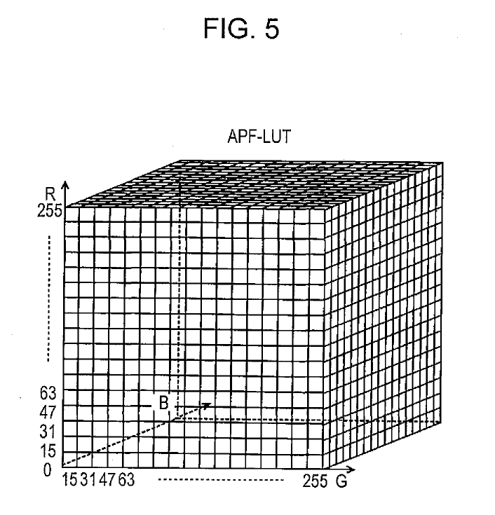

FIG. 5 is a diagram schematically illustrating the structure of the LUT (hereinafter, referred to as an APF-LUT), serving as the variable profile, created in Step S130. In FIG. 5, the eRGB color space is shown, and 17³ lattice points, which are combinations of R=0, 15, 31, . . . , 255, G=0, 15, 31, . . . , 255, and B=0, 15, 31, . . . , 255, are shown in the color space. Step S120 performs luminance correction on the input values on the lattice points using the spline curve to calculate output values, and create the APF-LUT defining the correspondences between the input values on the lattice points and the output values. In the APF-LUT, the correspondences between the input values and the input values are defined for some representative values. Therefore, interpolation needs to be performed in order to obtain output values corresponding to the other input values.

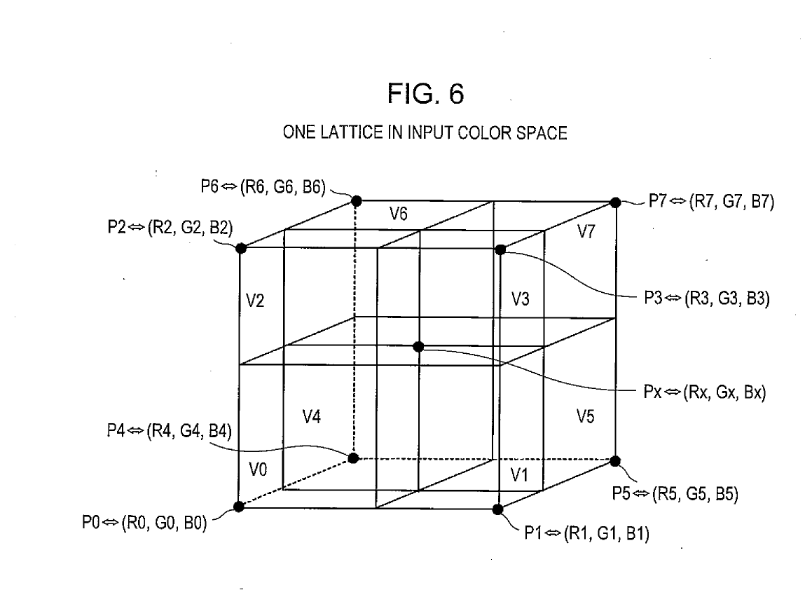

FIG. 6 is a diagram schematically illustrating an example of the interpolation process. In FIG. 6, hexahedron interpolation is performed as the interpolation process. In FIG. 6, a hexahedron of the eRGB space is formed by 8 lattice points P0 to P7 defined by the APF-LUT. The output values corresponding to the points P0 to P7 in the APF-LUT are represented by (R0 to R7, G0 to G7, B0 to B7), respectively. In this embodiment, the values of input RGB color signals are not matched with any one of the lattice points P0 to P7, and an RGB color signal Px is input inside the hexahedron surrounded by the points P0 to P7.

First, the volume V0 of a hexahedron having the point P0 and the point Px opposite to each other as its vertexes, the volume V1 of a hexahedron having the point P1 and the point Px opposite to each other as its vertexes, the volume V2 of a hexahedron having the point P2 and the point Px opposite to each other as its vertexes, the volume V3 of a hexahedron having the point P3 and the point Px opposite to each other as its vertexes, the volume V4 of a hexahedron having the point P4 and the point Px opposite to each other as its vertexes, the volume V5 of a hexahedron having the point PS and the point Px opposite to each other as its vertexes, the volume V6 of a hexahedron having the point P6 and the point Px opposite to each other as its vertexes, and the volume V7 of a hexahedron having the point P7 and the point Px opposite to each other as its vertexes (V0+V1+V2+V3+V4+V5+V6+V7=1) are calculated. The volumes V0 to V7 can be calculated from the coordinates of the points P0 to P7 and the point Px in the eRGB color space.

The RGB values (Rx, Gx, Bx) of the point Px can be calculated by Expression 1 given below:

Rx=V0*R7+V1*R6+V2*R5+V3*R4+V4*R3+V5*R2+V6*R1+V7*R0,

Gx=V0*G7+V1*G6+V2*G5+V3*G4+V4*G3+V5*G2+V6*G1+V7*G0, and

Bx=V0*B7+V1*B6+V2*B5+V3*B4+V4*B3+V5*B2+V6*B1+V7*B0. [Expression 1]

In Expression 1, the output values (Rx, Gx, Bx) corresponding to an arbitrary point Px are calculated by linearly combining the RGB values of the points P0 to P7 while weighting the volumes of the hexahedrons opposite to each other with the point Px interposed therebetween on the basis of the volumes V0 to V7. Such interpolation is sequentially performed to calculate as the output values (Rx, Gx, Bx) the RGB color signals obtained by correcting the luminance of the input value Px. That is, it is possible to convert an arbitrary input value into an output value using the APF-LUT. While hexahedron interpolation is illustrative, other interpolation methods can be applied to the invention. In the interpolation, it is necessary to calculate the volumes V0 to V7 of the hexahedrons, and thus an input value needs to be positioned inside the hexahedrons surrounded by the lattice points or at the boundaries between the hexahedrons. Therefore, in the APF-LUT according to this embodiment, in each of the RGB channels, an input value range of 0 to 255 can be converted.

In this embodiment, the variable profile is created as a three-dimensional LUT defining the output values corresponding to combinations (for example, 17³ lattice points) of the input values on the lattice points of the color signals of the RGB channels. However, since the color signals of the RGB channels do not depend on the conversion result, the variable profile may be created as a one-dimensional LUT.

In this embodiment, the variable profile is created for correcting the luminance, but the invention is not limited thereto. The variable profile may be created for other purposes. For example, the range of the color signal of each pixel may be calculated as feature information, and a variable profile for adjusting contrast may be created by variable parameters based on the range. In addition, a variable profile may be created in which a face color or a specific memorial color is extracted from the color signal of each pixel and the extracted color is used to correct a target face color or memorial color. Of course, a single variable profile may be used to adjust a plurality of image qualities at the same time. In this way, when the variable profile (APF-LUT) is set, the conversion sequence setting unit M3 sets a series of conversion processes in Step S140.

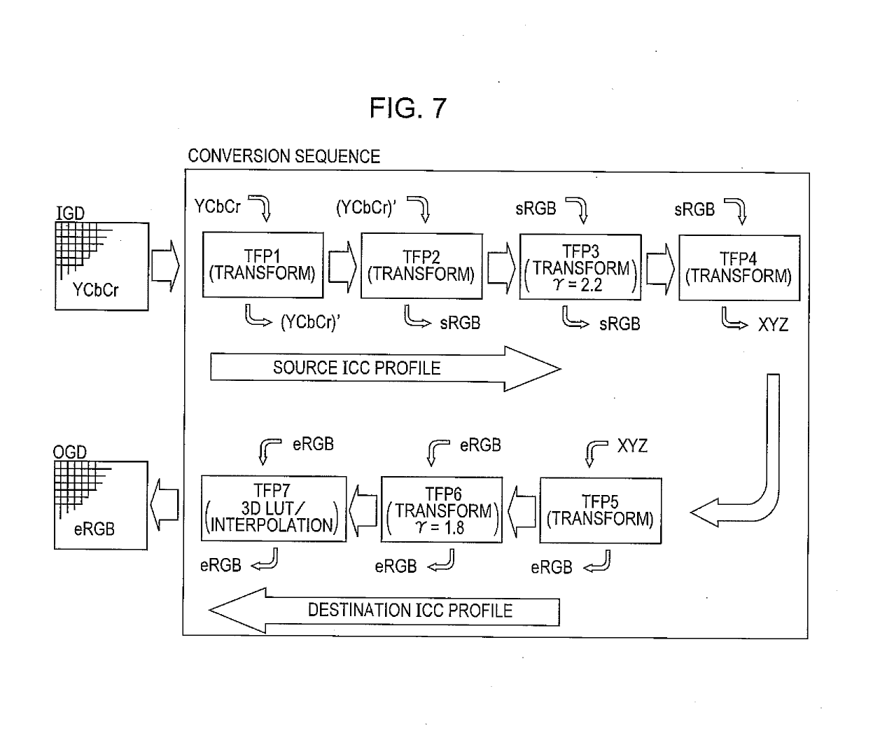

FIG. 7 is a diagram illustrating an example of the conversion sequence set in Step S140. As shown in FIG. 7, in this embodiment, the conversion sequence setting unit M3 sets a conversion sequence in which 7 conversion profiles TFP1 to TFP7 are sequentially used to convert the input image data IGD into the output image data OGD. According to the conversion sequence, the input image data IGD in the YCbCr color space is sequentially converted into the output image data OGD in the eRGB color space. First, the first conversion profile TFP1 is used to convert a color signal in the YCbCr color space into a color signal in a (YCbCr)′ color space. A transform that offsets (reduces) CbCr of an input color signal in the YCbCr color space by a predetermined amount to obtain a color signal and outputs the color signal as a color signal in the (YCbCr)′ color space is defined in the first conversion profile TFP1. Therefore, it is possible to obtain a color signal in the (YCbCr)′ color space that can be input to the second conversion profile TFP2 in the next stage.

The second conversion profile TFP2 is used to convert the color signal in the (YCbCr)′ color space into a color signal in an sRGB color space. In the second conversion profile TFP2, it is possible to convert the color signal in the (YCbCr)′ color space into a color signal in the sRGB color space by matrix transform. In addition, in the sRGB color space, it is possible to specify an absolute color by the RGB color signals. That is, the second conversion profile TFP2 can convert the color signal in the (YCbCr)′ color space that depends on the DSC 30 into a color signal in the sRGB color space, which is a device independent color space defined by a CIE standard. The second conversion profile TFP2 is generally called a source ICC profile, and is provided from, for example, a manufacturer of the DSC 30. The source ICC profile may be embedded in the input image data IGD, or it may be stored in the HDD 14 beforehand so as to be associated with the DSC 30.

The third conversion profile TFP3 is used to perform gamma correction on each of the RGB color signals in the sRGB color space. The gamma value (for example, the gamma value is 2.2 for each of the RGB color signals) suitable for input characteristics of the DSC 30 is designated as a portion of the source ICC profile. In this way, it is possible to specify the color indicated by each pixel of the input image data IGD in the sRGB color space. In general, the gamma correction is performed on a negative input value using a gamma correction curve that is symmetric with a gamma correction curve for a positive input value. The fourth conversion profile TFP4 is used to convert the color signal in the sRGB color space into a color signal in an XYZ color space. The XYZ color space is also an absolute color space defined by the CIE standard, and it is possible to convert the color signal in the sRGB color space into the color signal in the XYZ color space by setting a predetermined matrix transform as the fourth conversion profile TFP4. According to this conversion sequence, it is possible to specify the color indicated by the color signal of each pixel in the input image data IGD captured by the DSC 30 in the XYZ color space. Then, a conversion sequence for conversion into the color space used by the printer 20, which is an output device, is set.

The fifth conversion profile TFP5 is used to convert the color signal in the XYZ color space into a color signal in an eRGB color space, which is the RGB color space used by the printer 20, by matrix transform. The eRGB color space is a device dependent color space that depends on the printer 20, and an absolute color indicated by the RGB signals in the eRGB color space is defined by the destination ICC profile. The destination ICC profile is provided from, for example, a manufacturer of the printer 20. For example, the destination ICC profile may be read from the HDD 14, and used as the fifth conversion profile TFP5. The sixth conversion profile TFP6 is used to perform (inverse) gamma correction on each of the RGB color signals in the eRGB color space. The gamma value (for example, the gamma value is 1.8 for each of the RGB color signals) suitable for output characteristics of the printer 20 is designated as a portion of the destination ICC profile.

According to the conversion sequence, the obtained RGB color signals in the eRGB color space are finally corrected by the seventh conversion profile TFP7. The seventh conversion profile TFP7 is a conversion profile that corrects color signals in the eRGB color space, and corresponds to the variable profile according to this embodiment. The seventh conversion profile TFP7 is created by the above-described variable profile creating process (Step S130). In this embodiment, the conversion profiles TFP1 to TFP6 are fixed profiles that do not depend on the image of the input image data IGD, and the seventh conversion profile TFP7 is the variable profile that depends on the brightness of the image of the input image data IGD. The conversion sequence setting unit M3 recognizes the color space of the input image data IGD and the color space of the output image data OGD that can be output to the printer 20, and sets a series of conversion processes of converting the color space of the input image data IGD into the color space of the output image data OGD. The conversion profiles TFP1 to TFP7 required for the conversion processes can be acquired from information included in the input image data IGD or the HDD 14. In Step S150, the representative point selecting unit M4 selects the representative input points RIG defining the correspondence in the LUT.

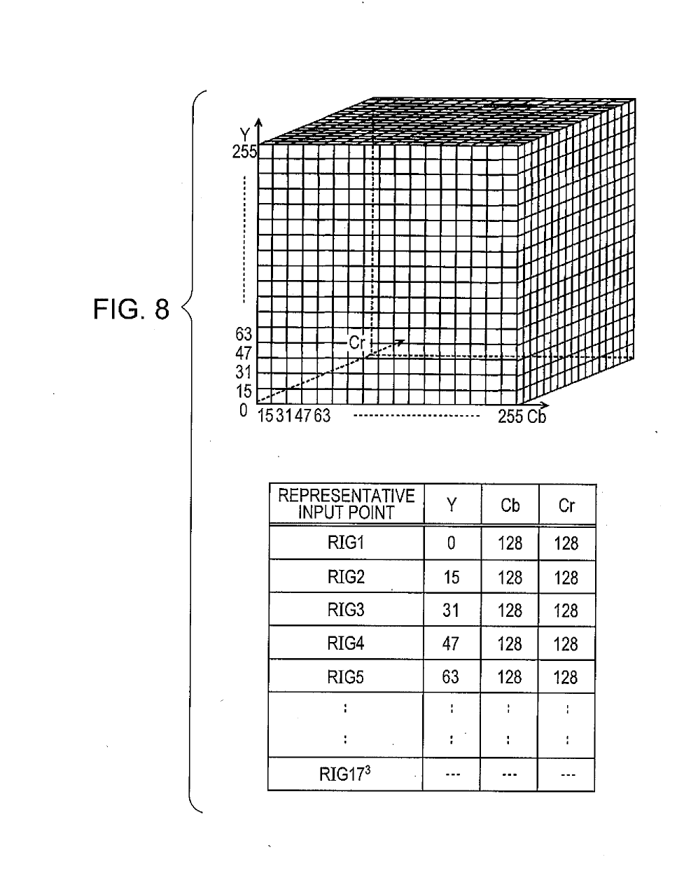

FIG. 8 is a diagram illustrating the distribution of the representative input points RIG selected by the representative point selecting unit M4 and a list of the representative input points RIG according to this embodiment. The representative input points RIG are specified by the color space of the input image data IGD (in this embodiment, the YCbCr color space). Specifically, FIG. 8 shows the distribution of the representative input points RIG in the YCbCr color space. The representative input points RIG are preferably uniformly distributed in the entire color space of the input image data IGD. In addition, in this embodiment, 17³ representative input points RIG on the 17×17×17 lattice points that uniformly divide three axes of the YCbCr color space are selected. In FIG. 18, only the lattices on the surface of the YCbCr color space are shown, but the representative input points RIG are uniformly selected inside the color space. In this embodiment, the representative input points RIG that are uniformly distributed in the entire YCbCr color space, which is the color space of the input image data IGD, are selected, but the invention is not limited thereto. The representative input points RIG may be selected on the basis of distribution in other color spaces. For example, the representative input points RIG may be selected so as to be uniformly distributed in the sRGB color space or the eRGB color space after conversion. In Step S160, the sequential conversion unit M5 acquires the representative input points RIG, and sequentially converts the representative input points RIG using the conversion profiles TFP1 to TFP7.

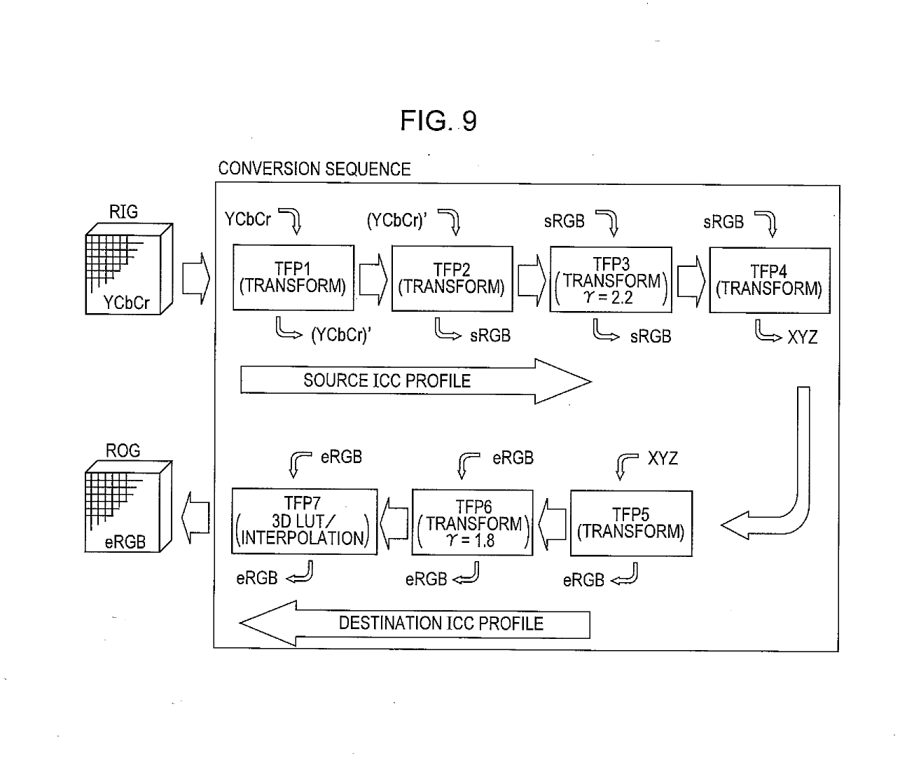

FIG. 9 is a diagram schematically illustrating a process of sequentially converting the representative input points RIG using the conversion profiles TFP1 to TFP7. In this case, the conversion processes are the same as a series of conversion processes that is set by the conversion sequence setting unit M3 in Step S140. Therefore, the color signals of the YCbCr color space are input as the representative input points RIG, and the color signals are sequentially converted by the conversion profiles TFP1 to TFP7, thereby finally obtaining the color signals in the eRGB color space, which is the color space of the output image data OGD. The finally obtained RGB signals in the sRGB color space are represented by the representative output points ROG.

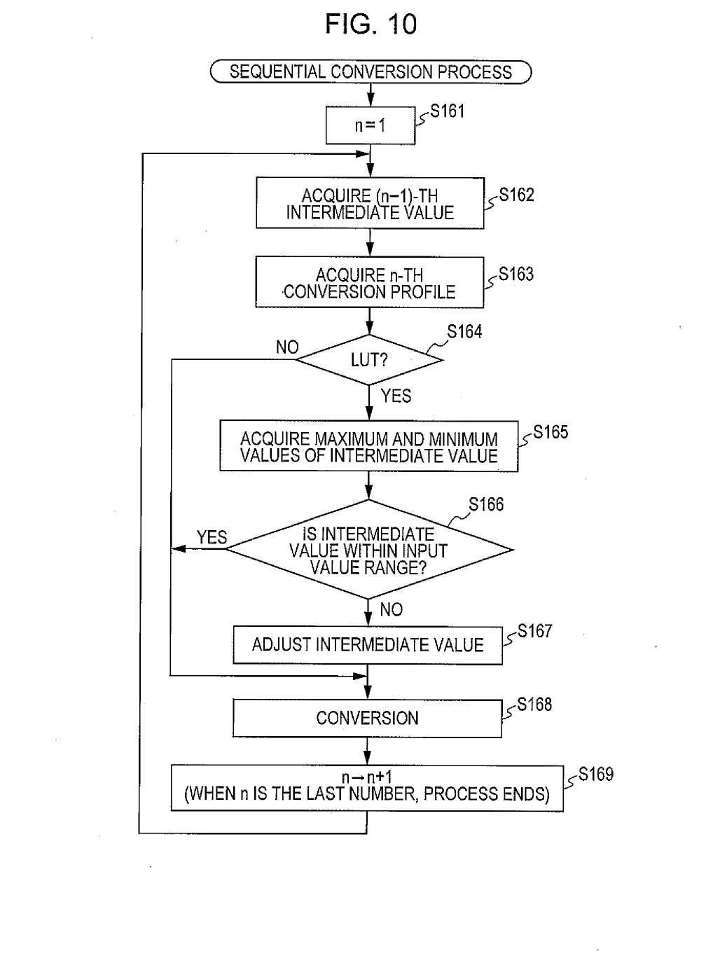

FIG. 10 is a flowchart illustrating a sequential conversion process performed by the sequential conversion unit M5 in Step S160. First, in Step S161, a variable n indicating the order of the conversion profiles TFP1 to TFP7 is set to an initial value 1. In Step S162, the sequential conversion unit M5 acquires an (n−1)-th intermediate value. The term ‘n-th intermediate value’ means an output value obtained by conversion by an n-th conversion profile. When n is 1, the representative input point RIG is acquired as an initial (n=0) intermediate value. In Step S163, the intermediate value adjusting unit M5a acquires the n-th conversion profile. In the initial stage, the conversion profile TFP1 that offsets the color signal in the YCbCr color space by a transform is acquired as the first conversion profile.

Step S164 determines whether the n-th conversion profile acquired in Step S163 is a transform or an LUT. When it is determined that the conversion profile is the transform, the (n−1)-th intermediate value (the representative input point RIG in the initial stage) acquired in Step S162 is input to the n-th conversion profile to calculate an intermediate value, which is a converted value (Step S168). In the initial stage, since the transform is acquired as the conversion profile TFP1, the representative input point RIG, which is an intermediate value when n=0, is input to the conversion profile TFP1. In Step S168, the (n−1)-th intermediate value is input to the n-th conversion profile to calculate an n-th intermediate value. When the n-th intermediate value is calculated, the variable n is incremented by 1 in Step S169, and the process returns to Step S162. Since the (n−1)-th intermediate value is acquired in Step S162, the previous intermediate value is acquired. In this embodiment, since the conversion profiles TFP1 to TFP6 are given as (matrix) transforms, the above-described processes are sequentially repeated until an intermediate value (n=6), which is a value converted by the conversion profile TFP6, is calculated.

Meanwhile, when the n-th conversion profile acquired in Step S163 is the LUT, the intermediate value adjusting unit M5a acquires the maximum and minimum values of the (n−1)-th intermediate value in Step S165. In this embodiment, when the variable n is 7, first, Step S165 is performed to acquire the maximum and minimum values of the sixth intermediate value (n−1=6) since the conversion profile TFP7 (APF-LUT) is the LUT. Since the intermediate value obtained by the sixth conversion profile TFP6 is output as RGB signals in the eRGB color space, the maximum and minimum values of each of the RGB channels are acquired. Further, in Step S165, the intermediate value adjusting unit M5a acquires the convertible input value range of the LUT serving as the n-th conversion profile. As described above, since it is necessary to perform interpolation during conversion by the LUT, the range in which the lattice points exist in the LUT is the convertible input value range. In this embodiment, the range of 0 to 255 in each of the RGB channels in the APF-LUT, serving as the seventh conversion profile TFP7, is the convertible input value range. Step S166 determines whether the maximum and minimum values of the (n−1)-th intermediate value are within the input value range that can be converted by the n-th LUT.

When it is determined that the maximum and minimum values of the (n−1)-th intermediate value are within the convertible input value range, the process proceeds to Step S168 to input the (n−1)-th intermediate value to the n-th conversion profile. Since it is certain in Step S167 that the input of the intermediate value is available, it is possible to perform conversion by interpolation using the LUT. On the other hand, when it is determined that the maximum and minimum values of the (n−1)-th intermediate value are out of the convertible input value range, it is difficult to perform conversion using the intermediate value. Therefore, the process proceeds to Step S167 to adjust the (n−1)-th intermediate value.

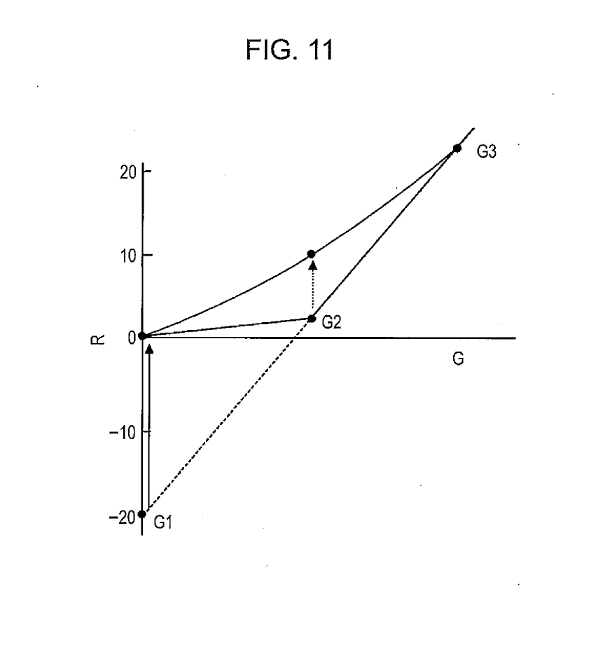

FIG. 11 is a graph illustrating the adjustment of the intermediate value performed in Step S167. In this embodiment, it is assumed that the minimum value of an R signal, which is the sixth intermediate value, is −20 which is out of the value range of 0 to 255 of the R channel that can be input to the APF-LUT serving as the seventh conversion profile TFP7. FIG. 11 shows an RG plane when there is the intermediate value of the G channel. In FIG. 11, the horizontal axis indicates a G channel value of the intermediate value and the vertical axis indicates an R channel value of the intermediate value. In addition, in FIG. 11, the intermediate values converted by the conversion profiles TFP1 to TFP6 are plotted as symbols ‘’. In this case, only the value (−20) of the R signal, which is the intermediate value, at the lattice point G1 is smaller than 0. Therefore, it is necessary to adjust the value of the R signal at the lattice point G1 to a value greater than 0 that can be input to the APF-LUT.

The value of the R signal at the lattice point G1 is changed to a lower limit value 0 that can be input to the APF-LUT. In this way, it is possible to input the lattice point G1 to the APF-LUT. When only the lattice point G1 is adjusted, the value of the R signal can be adjusted to the lower limit value that can be input to the APF-LUT. Values around the input value range may also be adjusted during the adjustment of the lattice point G1. For example, the value of the R signal at a lattice point G2, which is greater than 0, may be adjusted in consideration of the positional relationship among the lattice points G1, G2, and G3. When an angle formed between a segment G1G2 and a segment G3G2 is smaller than 90°, the interpolation result using the lattice point G2 may be unnatural. In this case, the value of the R signal at the lattice point G2 may also be increased such that an obtuse angle is formed between the segment G1G2 and the segment G3G2. As adjustment aspects, it is considered that a value smaller than the lower limit of the input value range is changed to be equal to or larger than the lower limit or a value larger than the upper limit of the input value range is changed to be equal to or smaller than the upper limit. When such adjustment is completed, interpolation is performed with reference to the APF-LUT in Step S168 to calculate a final representative output point ROG.

In the above-described sequential conversion process, only when the n-th conversion profile is the LUT, the intermediate value is adjusted. However, when the n-th conversion profile is the transform, the intermediate value is not adjusted. In this way, it is possible to keep the wide range of the intermediate value and prevent the loss of information of the intermediate value. Next, the reason is described.

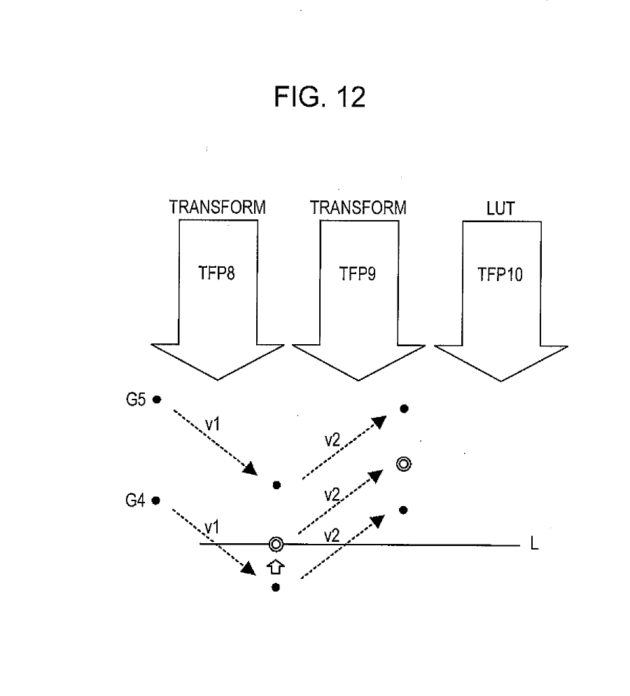

FIG. 12 is a diagram illustrating the sequential conversion of the intermediate value by three conversion profiles (conversion profiles TFP8 and TFP9, which are transforms different from those according to this embodiment, and a conversion profile TFP10, which is an LUT). The conversion profile TFP8 converts a lattice point G4 into an intermediate value (which is represented by a symbol ) smaller than a lower limit value L that can be input to the conversion profile TFP10, and the conversion profile TFP9 converts the lattice point G4 into the next intermediate value (which is represented by a symbol ). Since the intermediate value converted by the conversion profile TFP9 is larger than the lower limit value L, it can be input to the conversion profile TFP10. Values around the lattice point G4 are converted by the conversion profile TFP8 as a vector v1, and the values are converted by the conversion profile TFP9 as a vector v2.

Since the lattice point G4 converted by the conversion profile TFP8 is smaller than the lower limit value L, the lattice point G4 is adjusted to be equal to the lower limit value L (which is represented by a symbol ⊙). Then, the conversion profile TFP9 converts the lattice point G4 into an intermediate value (which is represented by a symbol ⊙) that is considerably larger than the lower limit value L that can be input to the conversion profile TFP10 by the vector v1. In this case, generally, only the intermediate values in the range that is narrower than the input value range of the conversion profile TFP10 can be input to the conversion profile TFP10. Therefore, the color gamut is narrowed. In addition, since unnecessary adjustment is performed, a processing load increases.

From the relationship between the lattice point G4 and a lattice point G5 adjacent to each other, when the lattice point G4 is converted to be larger than the lower limit value, the distance between the lattice points G4 and G5 is shorter than when the lattice point G4 is not converted to be larger than the lower limit value. As the distance between the lattice points G4 and G5 decreases, it is more difficult to achieve high grayscale resolution between the lattice points G4 and G5. Therefore, in this embodiment, unnecessary adjustment is not performed, and high grayscale resolution is achieved.

When the representative output points ROG for all the representative input points RIG are calculated, in Step S170, the LUT creating unit M6 creates a three-dimensional LUT (hereinafter, referred to as a composite LUT) defining the correspondences between the representative input points RIG and the representative output points ROG before and after the conversion sequence setting unit M3 performs conversion. Since 17³ representative input points RIG are selected, 17³ correspondences between the representative input points RIG and the representative output points ROG are written in the composite LUT.

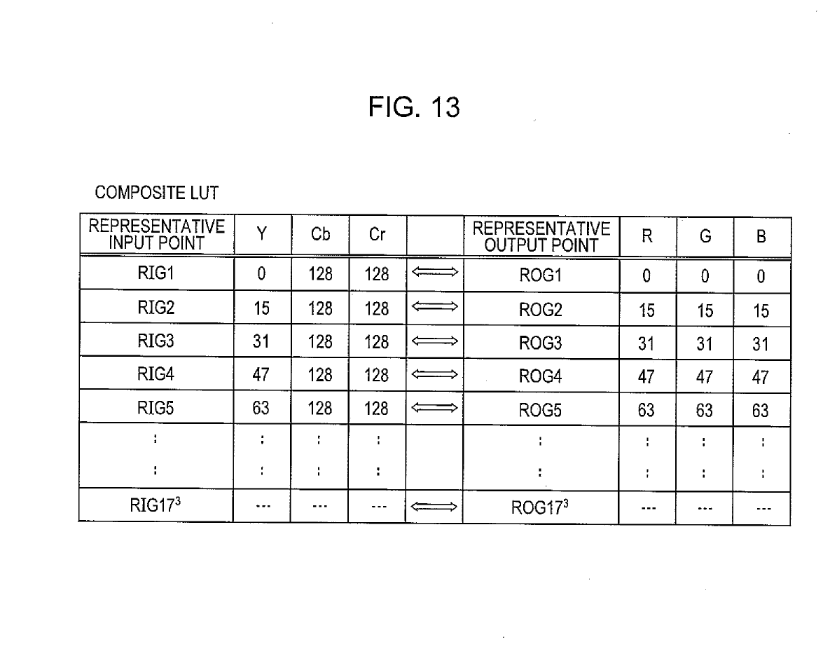

FIG. 13 is a diagram illustrating an example of the composite LUT. In the composite LUT shown in FIG. 13, the representative input points RIG and the representative output points ROG are associated with each other in the horizontal direction, and the values of the color signals of the representative input points RIG and the representative output points ROG are written. The composite LUT is stored in, for example, the RAM 12. Steps S100 to S170 are preliminary image converting processes and referred to as an initialization phase. In the initialization phase, when the composite LUT is completely created, a conversion phase after Step S180 is executed. In Step S180, the LUT converting unit M7 acquires the input image data IGD, and converts the input image data IGD into the output image data OGD with reference to the composite LUT.

Specifically, the LUT converting unit M7 acquires the YCbCr color signals of the pixels in the input image data IGD, and acquires RGB color signals in the eRGB color space corresponding to the YCbCr color signals with reference to the composite LUT. In this case, the conversion is performed using interpolation. The interpolation may be performed by the same method as described with reference to FIG. 6. When the RGB color signals of all the pixels in the input image data IGD are calculated, image data including the RGB color signals of the pixels is generated as the output image data OGD. The generated (converted) output image data OGD is output to the printing data generating unit M8 in Step 190, and the printing data generating unit M8 converts the received output image data OGD into printing data that can be processed by the printer 20. In this way, the printer 20 operates on the basis of the printing data to print an image corresponding to the input image data IGD.

In the conversion phase in which the input image data IGD is actually converted into the output image data OGD (Step S180), only one interpolation process is needed to complete a series of conversion processes corresponding to the conversion profiles TFP1 to TFP7. Therefore, a high-speed conversion process is achieved. In addition, in the conversion phase, all pixels in the input image data IGD are converted (interpolated), but in the initialization phase including Steps S100 to S170, limited objects, that is, only the representative input points RIG are converted in Step S160. Therefore, the processing time of the initialization phase is shorter than that of the conversion phase. For example, when input image data IGD having more than 500 megapixels is input, the conversion phase requires a lot of time. Therefore, even though the initialization phase is performed beforehand, the merit of the structure according to this embodiment capable of completing the conversion phase with only one interpolation is remarkable.

The composite LUT referred to during the conversion phase (Step S180) is created in consideration of the conversion result by the conversion profile TFP7 that is created on the basis of the variable parameter (luminance correction amount Bmod) obtained by statistics of the brightness of the input image data IGD. Therefore, luminance correction according to the brightness of the input image data IGD is performed simultaneously with the conversion of the color space. In this way, when the input image data IGD is dark, image quality can be adjusted such that the brightness of the input image data IGD increases. Since the composite LUT is created according to the input image data IGD, it is possible to adjust the image quality according to the input image data IGD.

### (3) Modifications

The above-described conversion sequence is merely illustrative and not limiting. The conversion sequence setting unit M3, for example, may set another conversion sequence according to the color space of the input image data IGD, which is a printing object. For example, in FIG. 7, when input image data IGD in which the colors of the pixels are represented by the color signals in the sRGB color space is input, the conversion profiles TFP1 to TFP3 are not needed, and only the conversion sequence of the conversion profiles TFP4 to TFP7 is set. That is, the invention can be applied to destination-side conversion. In FIG. 7, a composite LUT defining the correspondences between values (YCbCr-sRGB (XYZ)) before and after source-side conversion (conversion profiles TFP1 to TFP3 (4)) may be created, and the source-side conversion may be collectively performed by the composite LUT. Quality adjustment by the variable profile may be performed on image data in the YCbCr, sRGB, or XYZ color space, and the conversion result by the variable profile may be incorporated in the source-side composite LUT.

In the above-described embodiment, when the luminance correction amount Bmod is 0% in Step S120, luminance correction by the variable profile is not substantially needed. Therefore, the conversion profile TFP7, serving as the variable profile, may be omitted in the conversion sequence. In this case, there is no conversion process using the LUT after the conversion profile TFP6, and the intermediate value is not adjusted after the conversion profile TFP6. According to this embodiment, conversion processes are collectively performed with reference to the composite LUT that defines the correspondences between the input values and the output values of a series of two or more conversion profiles. As a result, high-speed conversion processing is achieved. The individual conversion profiles are not limited to the above-described embodiment. For example, a color conversion profile for converting input image data into image data indicating the amount of each ink in a printing apparatus or a calibration profile that is created by calibration in the printing apparatus may be incorporated into the composite LUT of a series of conversion profiles according to the above-described embodiment. In addition, the invention is not limited to conversion between an input device and an output device, and can be applied to other conversion processes based on the printing according to the above-described embodiment. For example, the invention can be applied to conversion from image data in the sRGB color space into image data in an AdobeRGB color space (Adobe is a trademark registered by Adobe Systems Incorporated).

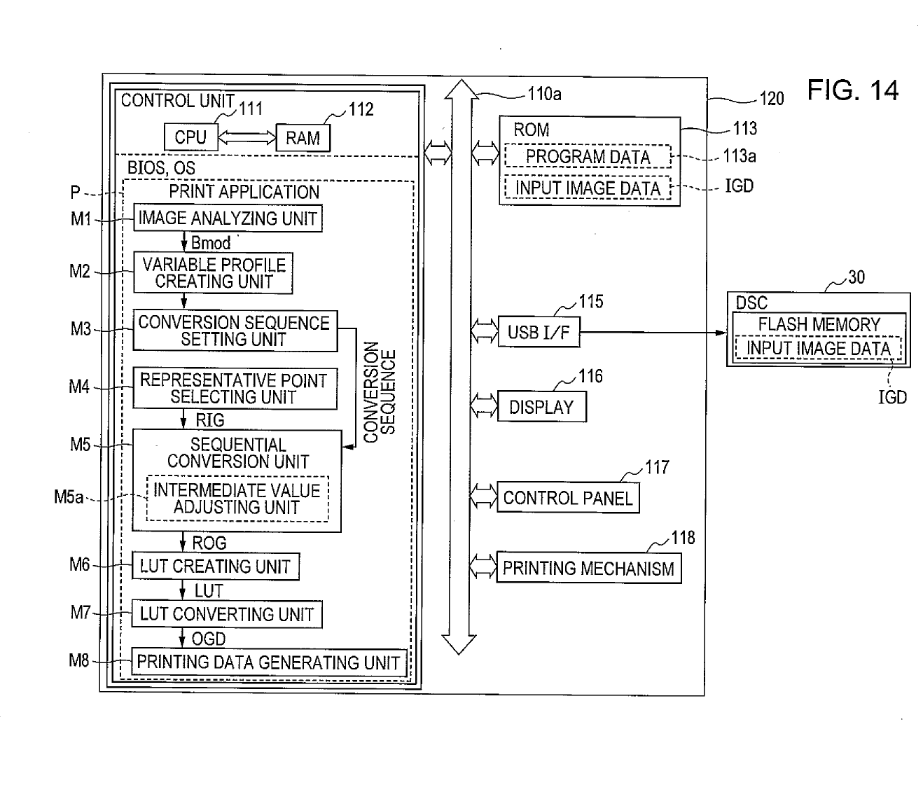

FIG. 14 is a diagram illustrating the structure of an image converting apparatus according to a modification of the invention. In FIG. 14, a control unit C of a printer 120 performs the same functions as those in the above-described embodiment. That is, the printer 120 has a so-called direction print function. The control unit C executes a print application P, and the printer 120 performs the same image converting process as described above. In general, a CPU and a RAM provided in the printer 120 have lower processing capabilities than those provided in a personal computer. Therefore, when the invention capable of reducing the number of interpolation processes having a large processing load is applied to this structure, the effects of the invention are remarkable.

What is claimed is:

1. A method of creating a composite lookup table referred to in case lattice points distributed in a color space of first image data are sequentially converted into lattice points distributed in a color space of second image data by a plurality of conversion profiles, the method comprising:
adjusting an intermediate value converted by a conversion profile so that the intermediate value is within an input value range of a corresponding lookup table and inputting the adjusted intermediate value to a next conversion profile in case an input value range of the next conversion profile is limited;
inputting the intermediate value converted by the previous profile to the next conversion profile without any adjustment in case the input value range of the next conversion profile is not limited; and
creating the composite lookup table that defines correspondences between the lattice points distributed in the color space of the first image data and the lattice points distributed in the color space of the second image data.

2. The composite lookup table creating method
wherein, in the adjustment of the intermediate value,
in case the next conversion profile is a lookup table, the intermediate value obtained by conversion by the previous conversion profile is adjusted to be within the input value range of the lookup table, and the adjusted intermediate value is input to the next conversion profile, and
in case the next conversion profile is-a transform, the intermediate value obtained by conversion by the previous conversion profile is input to the next conversion profile without any adjustment.

3. The composite lookup table creating method according to claim 2,
wherein, in the adjustment of the intermediate value, in case the input value range of the lookup table is limited to a value that is equal to or larger than 0, a negative intermediate value is adjusted to be equal to or larger than 0.

4. The composite lookup table creating method according to claim 3,
wherein, in the adjustment of the intermediate value, the intermediate values out of the input value range of the lookup table as well as the intermediate values around upper and lower limits of the input value range of the lookup table are adjusted.

5. The composite lookup table creating method according to claim 4,
wherein, in the adjustment of the intermediate value, continuity between the adjusted value of the intermediate value out of the input value range of the lookup table and the adjusted value of the intermediate value around the upper and lower limits of the input value range of the lookup table is maintained.

6. An image processing apparatus for converting first image data into second image data using a lookup table that is created by the composite lookup table creating method according to claim 1.

7. An apparatus for creating a composite lookup table referred to when first image data is converted into second image data by a plurality of conversion profiles, the apparatus comprising:
a sequential conversion unit that sequentially converts lattice points distributed in a color space of the first image data using the plurality of conversion profiles to acquire lattice points distributed in a color space of the second image data;
an adjusting unit that, during the sequential conversion of the lattice points distributed in the color space of the first image data by the sequential conversion unit, adjusts an intermediate value converted by a conversion profile so that the intermediate value is within an input value range of a corresponding lookup table and inputs the adjusted intermediate value to a next conversion profile in case an input value range of the next conversion profile is limited, and inputs the intermediate value converted by the previous profile to the next conversion profile without any adjustment in case the input value range of the next conversion profile is not limited; and
a creating unit that creates the composite lookup table defining correspondences between the lattice points distributed in the color space of the first image data and the lattice points distributed in the color space of the second image data.
